(19) United States
(12) Patent Application Publication
(10) Pub. No.: US 2026/0267036 A1
(43) Pub. Date: Sep. 10, 2026

(54) LENS ARRAY AND OPTICAL REFRACTIVE PANEL AND SPECTACLES LENS

(71) Applicant: Gideon DOTAN, Yehud-Monoson (IL)

(72) Inventor: Gideon DOTAN, Yehud-Monoson (IL)

(21) Appl. No.: 19/578,998

(22) Filed: Mar. 26, 2026

Related U.S. Application Data
(63) Continuation of application No. 18/226,806, filed on Jul. 27, 2023.

(30) Foreign Application Priority Data
Aug. 8, 2022 (IL) 295439

(51) Int. Cl. G02B 3/00; G02C 7/14

(52) U.S. Cl. CPC G02B 3/0056; G02B 3/0025; G02B 3/0031; G02C 7/14

(57) ABSTRACT

A lens array, including a plurality of lenses each including an optical refractive substance, the lenses being disposed one aside the other, and partitions disposed between the optical refractive substances of the lenses.

### CROSS-REFERENCE TO RELATED APPLICATIONS

This application is a continuation of U.S. patent application Ser. No. 18/226,806, filed Jul. 27, 2023, which claims the benefit of priority from Israel Patent Application No. 295439, filed Aug. 8, 2022, the disclosure of which is incorporated herein by reference.

### TECHNICAL FIELD

The invention relates to the field of lenses and spectacles.

### BACKGROUND

FIG. 1 schematically depicts proper imaging of the eye.

An object 18 is shown imaged by the lens 20 of the human eye 22 to form an image 24A on the retina 26, being the sensor converting illumination to electric signals.

FIG. 2 schematically depicts an image on the retina with a defect in the macula so non-proper imaging is provided to the brain.

In case retina 26 includes a defective area 28, or other disease including lowering resolution of the retina, a portion 30 of image 24A is not converted to electric signals. In this shown case portion 30 is large in relation to image 24A, thus most of image 24A is not viewed by the user.

FIG. 3 is a front perspective view of prior art spectacles, for overcoming the failure shown in FIG. 2.

Prior art spectacles 12 for reducing the loss of defective area 28, conventionally include in addition to conventional lenses 14, a telescope 16A attached to each lens, for magnifying image 24A at the retina.

FIG. 4 schematically depicts exemplary lenses of the prior art telescope of FIG. 3 and schematic ray tracing provided thereby.

Telescope 16A of FIG. 3 may include a positive lens 32A, a negative lens 32B, and an air gap 32C therebetween.

Telescope 16A produces parallel rays 34 of angle 36B from parallel rays 34 of angle 36A, wherein angle 36B is larger than angle 36A, for magnifying the image on the retina.

FIG. 5 schematically depicts the enlarged image on the retina, enabling recognizing details even on the low resolution area of the retina and the reduction of the loss obtained by the prior art spectacles of FIG. 3.

Even though retina 26 includes defective area 28 and portion 30 of image 24B is not converted to electric signals, telescope 16A of FIG. 3 produces a magnified image 24B, thus portion 30 is small in relation to magnified image 24B, thus most of image 24A is viewed by the user. The magnification of the image allows the user to recognize even upon poor resolution of this part of the retina.

However and referring to FIG. 3, telescope 16A is cumbersome.

There is a long felt need to provide a solution to the above-mentioned and other problems of the prior art.

### SUMMARY

A lens array, including:
a plurality of lenses; and
partitions disposed between optical refractive substances of the lenses.

Spectacles including lens array with partitions between the array lenses

### BRIEF DESCRIPTION OF THE DRAWINGS

Embodiments, features, and aspects of the invention are described herein in conjunction with the following drawings:

FIG. 1 schematically depicts proper imaging of the eye;

FIG. 2 schematically depicts an image on the retina with a defect in the macula so non-proper imaging is provided to the brain;

FIG. 3 is a front perspective view of prior art spectacles, for overcoming the failure shown in FIG. 2;

FIG. 4 schematically depicts exemplary lenses of the prior art telescope of FIG. 3 and schematic ray tracing provided thereby;

FIG. 5 schematically depicts the enlarged image on the retina, enabling recognizing details even on the low resolution area of the retina and the reduction of the loss obtained by the prior art spectacles of FIG. 3;

FIG. 6 is a schematic front perspective view of spectacles according to one embodiment of the invention, for overcoming the failure shown in FIG. 2;

FIG. 7 is a front perspective view of spectacles according to another embodiment;

FIG. 8 schematically depicts exemplary lenses of a refractive panel and ray tracing provided thereby;

FIG. 9 is a rear perspective view of the schematic spectacles of FIG. 6;

FIG. 10 schematically depicts exemplary lenses of FIG. 8 together with the partitions of FIG. 6, and the ray tracing provided thereby;

FIG. 11 depicts the refractive panel of FIG. 10 according to another embodiment;

FIG. 12 depicts ray tracing from the refractive panel of FIG. 10 design as a telescopic lens array, to the retina;

FIG. 13 depicts the lens array of FIG. 10 according to another embodiment;

FIG. 14 depicts the lens array of FIG. 10 having different shaping of the partitions;

FIG. 15 depicts the lens array of FIG. 10 having different shaping of the partitions;

FIG. 16 depicts another design of lens array with an integrated grid in the panel as partitions;

FIG. 17 describes the first step of producing the partition of lens array of FIG. 13 or FIG. 14 according to one embodiment;

FIG. 18 describes the second step of producing the lens array of FIG. 13 or FIG. 14;

FIG. 19 describes the third step of producing the lens array of FIG. 13 or FIG. 14;

FIG. 20 describes the fourth step of producing the lens array of FIG. 13 or FIG. 14;

FIG. 21 describes the production of the lens array of FIG. 13 or FIG. 14 or FIG. 15 according to another embodiment;

FIG. 22 is similar to FIG. 12, except for an addition of a prism;

FIG. 23 is similar to FIG. 13, except for an addition of a lens;

FIG. 24 is similar to FIG. 13, except for an addition of an optical correction plate.

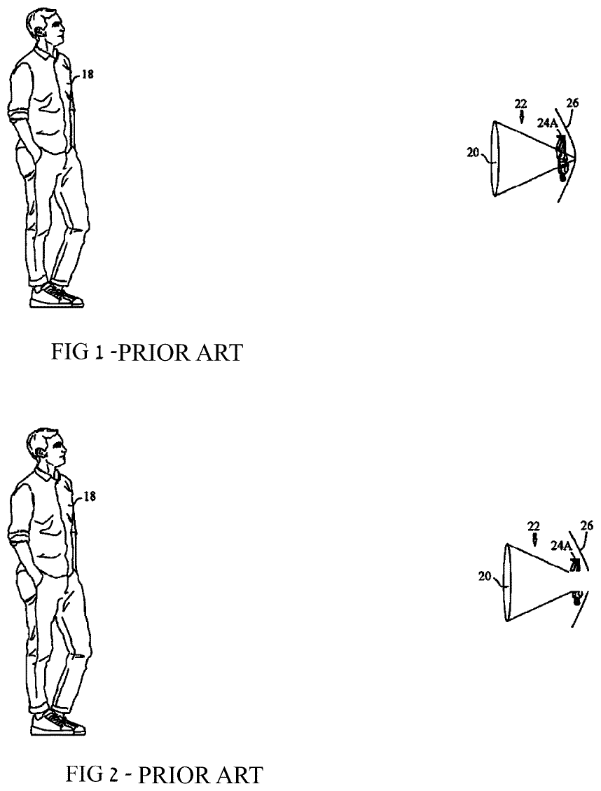

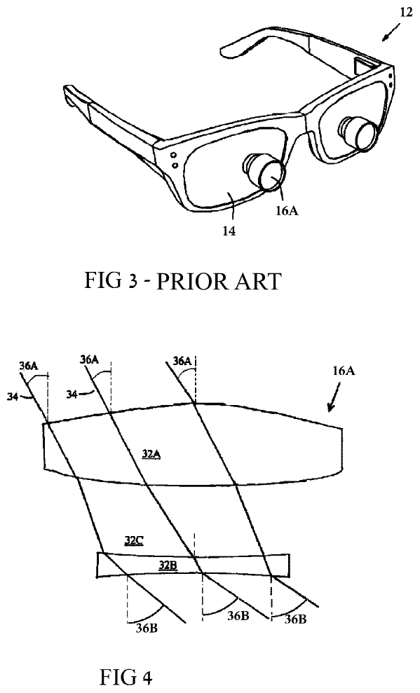

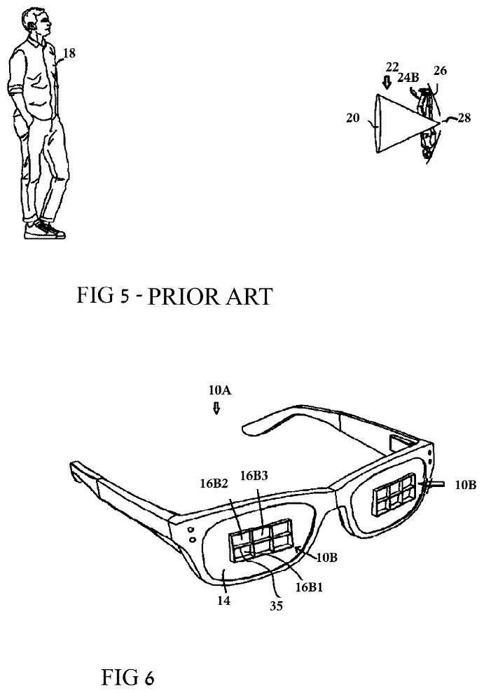

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

FIG. 6 is a schematic front perspective view of spectacles according to one embodiment of the invention, for overcoming the failure shown in FIG. 2.

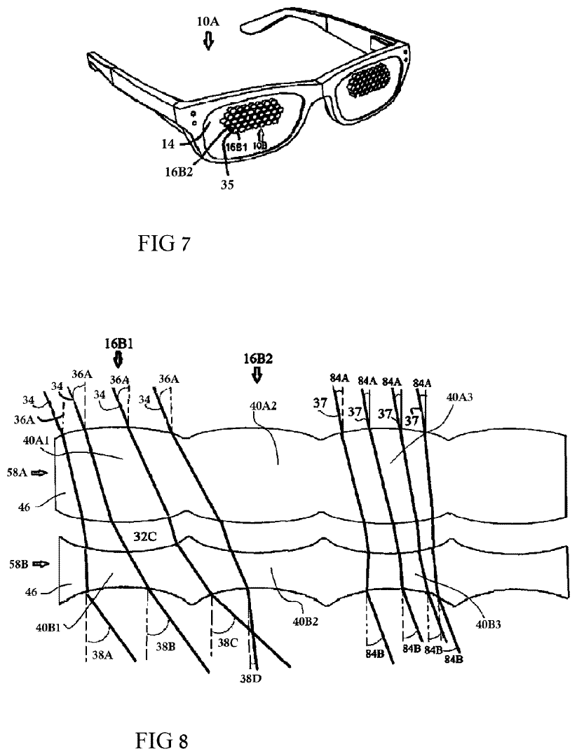

FIG. 7 is a front perspective view of spectacles according to another embodiment.

Spectacles 10A for reducing the loss of defective area 28, according to one embodiment of the invention, include in addition to conventional lenses 14, a refractive panel 10B according to one embodiment of the invention, accompanying each lens 14 of spectacles or constituting a portion or all of lens 14, for magnifying the image on the retina.

Refractive panel array 10B may include a telescope 16B1, a telescope 16B2, 16B3, etc.

FIG. 8 schematically depicts exemplary lenses of a refractive panel and ray tracing provided thereby.

Telescope 16B1 of FIG. 6 may include a positive lens 40A1 of transparent substance 46, a negative lens 40B1 of transparent substance 46, and an air gap 32C therebetween, so that the focal points of both lenses overlap; telescope 16B2 of FIG. 6 may include a positive lens 40A1 of transparent substance 46, a negative lens 40B1 of transparent substance 46, and air gap 32C therebetween so that the focal points of both lenses overlap; etc.

Thus, positive lenses 40A1, 40A2, 40A3 constitutes a first lens array 58A; and positive lenses 40B1, 40B2, 40B3 constitutes a second lens array 58B.

Rays 37 with small angle 84A of incidence exit lens 40B3 with angle 84B without leaking to neighboring another telescope channel.

Telescope 16B1 is intended to exit parallel rays 34 of FIG. 4 therefrom having angle 36B of FIG. 4 from entering parallel rays 34 of angle 36A of FIG. 4 being larger then angles of rays 37, wherein angle 36B of FIG. 4 is larger than angle 36A, for magnifying the image.

However, some of rays 36A entering telescope 16B1 enter telescope 16B2 as well. For example ray 42 entering lens 40A1 of telescope 16B1 enters lens 40B2 of telescope 16B2, and thus ray 42 is bent to angle 36D being wrong and different from angle 36B.

Referring again to FIG. 6, refractive panel 10B further includes partitions 35 between telescopes 16B1, 16B2, 16B3, etc. for preventing leakage of rays from one telescope channel to its neighbors.

FIG. 9 is a rear perspective view of the schematic spectacles of FIG. 6.

As shown in FIG. 6 and in FIG. 9, partitions 35 may extend from the front to the rear of each of telescopes 16B1, 16B2, etc.

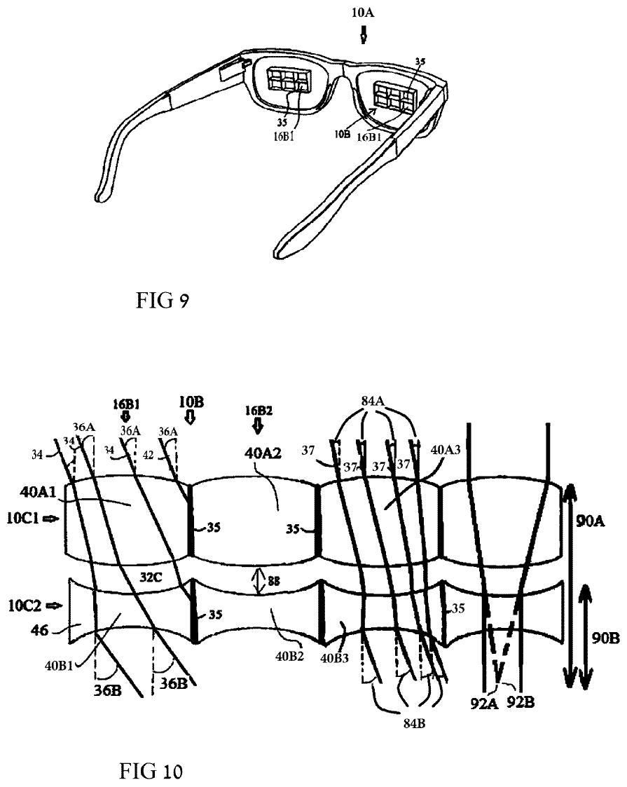

FIG. 10 schematically depicts exemplary lenses of FIG. 8 together with the partitions of FIG. 6, and the ray tracing provided thereby.

Refractive panel 10B may include lens arrays 10C1 and 10C2, in which positive lenses 40A1, 40A2, etc. and partitions 35 therebetween constitute lens array 10C1; and positive lenses 40B1, 40B2, etc., and partitions 35 therebetween constituting lens array 10C2. Air gap 32C is present between panels 10C1 and 10C2.

Partition 35 disposed between lenses 40A1 and 40A2 blocks or reduces or stops ray 42 entering lens 40A1 of telescope 16B1 from reaching lens 40B2 of telescope 16B2, and thus ray 42 does not distort the image.

Except for partitions 35, lens 40A1 of lens array 10C1 is attached to lens 40A2, and lens 40A2 is attached to lens 40A3, thus the fill factor of lens array 10C1 is almost 100%. However, the fill factor should be greater than 60%.

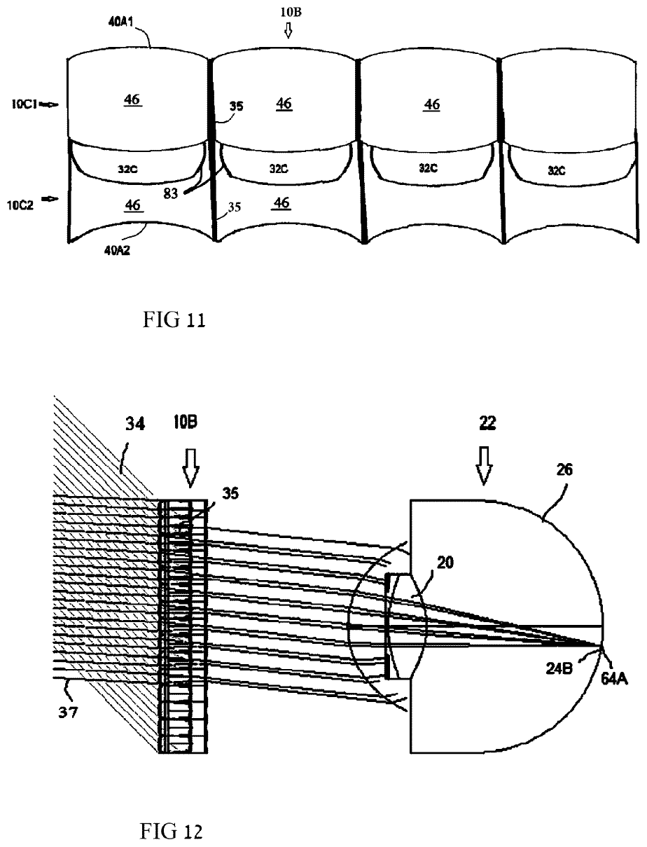

In FIG. 10, air gap 32C is present between lens array 10C1 and lens array 10C2. However, partitions 35 are not disposed within air gap 32C, thus partitions 35 disposed within the lens array panels will not block possible ray leakage to neighbored channels. The solution for these cases is described in FIG. 11.

Lens arrays 10C1 and 10C2 may form an array of Galilean telescopes 16B1, 16B2, etc. in that focal lengths 90A of lenses 40A1, 40A2, etc. of lens array 10C1 produces a focal point 92A, and focal lengths 90B of lenses 40B1, 40B2, etc. of lens array 10C2 produces a focal point 92B, and in that length 88 of gap 32C provides that focal point 92A overlaps focal point 92B.

Thus, refractive panel array 10B may be named “Galilean telescopic lens array”.

FIG. 11 depicts the refractive panel of FIG. 10 according to another embodiment.

Negative lens 40A2 may be shaped to include an extension 83 for extending to positive lens 40A1 and so on with others, for mechanically connecting lens arrays 10C1 and 10C2 one to the other.

Partitions 35 may extend in lens arrays 10C1 and 10C2 within extension 83 and will prevent leakage of rays from one telescopic channel to its neighbors.

Extension 83 may provide accurate mechanical fixing of lens arrays 10C1 and 10C2 one to the other, together with providing air gaps 32C therebetween.

FIG. 12 depicts ray tracing from the refractive panel of FIG. 10 design as a telescopic lens array, to the retina.

Lens 20 of human eye 22 together with refractive panel 10B of spectacles 10A, designed as a telescopic lens array, focus the infinity rays 37 on retina 26, while partitions 35 block penetration of rays 34 having large angle 36A, from penetrating to adjacent lenses/channels as shown in FIG. 10, thus avoid blurring or masking the image.

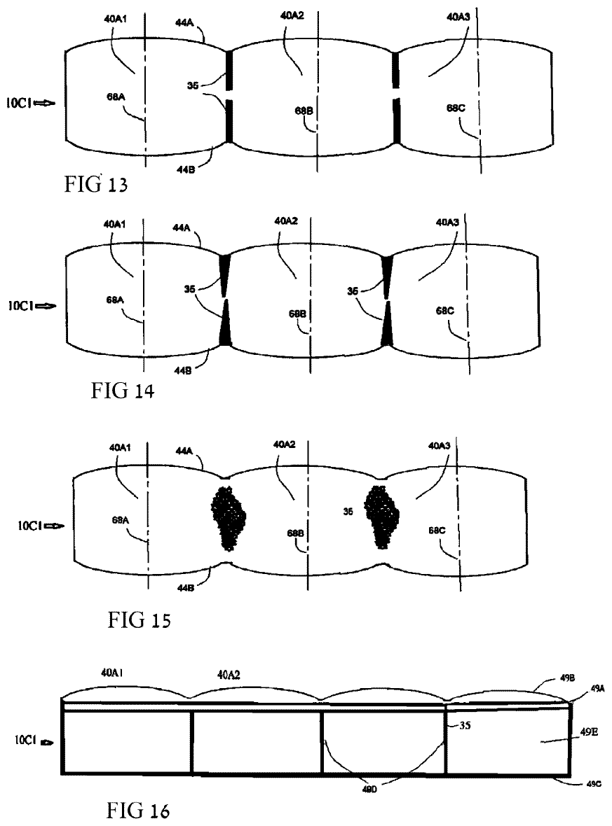

FIG. 13 depicts the lens array of FIG. 10 according to another embodiment.

Lenses 40A1, 40A2, etc. of lens array 10C1 include equal characters, such as equal focal length; and their optical axes namely axis 68A of lens 16B1 and axis 68B of lens 16B1, etc. and are parallel.

Partitions 35 may but need not extend from side 44A to side 44B, but may rather be shaped according to optical tracing considerations.

FIG. 14 depicts the lens array of FIG. 10 having different shaping of the partitions.

Partition 35 may be trapezial shape or include a tilt or other shaping according to partition manufacturing and according to optical tracing considerations.

FIG. 15 depicts the lens array of FIG. 10 having different shaping of the partitions.

Partition 35 may be shaped for stopping or reducing or blocking rays from penetrating into adjacent lenses also for functioning as an optical stop.

FIG. 16 depicts another design of lens array with an integrated grid in the panel as partitions.

Lens array 10C1 may include a plurality of lens assemblies 49C. Lens assembly 49C may be manufactured by applying a polymer layer 49A on a glass or plastic parallel-wall panel 49E and a lens array 49B applied on polymer layer 49A. Lens assemblies 49C are replicated or photo-lithographed in this layer. Partition 35 in this case can be performed in the panel by combining a grid 49D in panel 49E while it is molded.

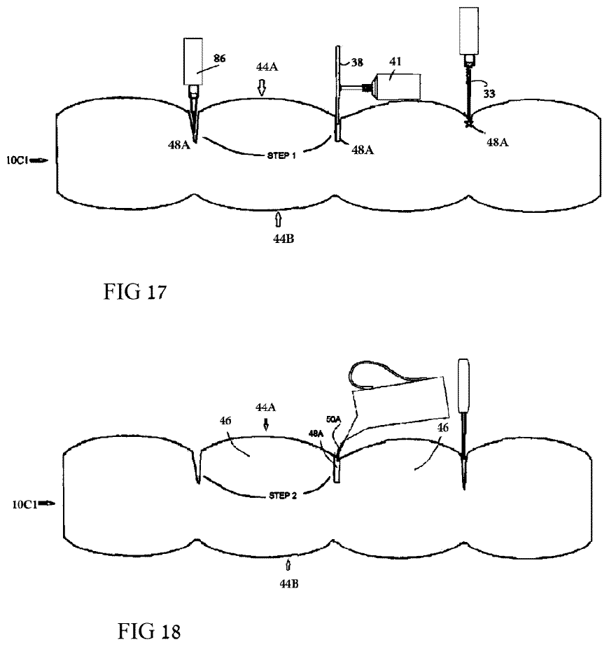

FIG. 17 describes the first step of producing the partition of lens array of FIG. 13 or FIG. 14 according to one embodiment.

Lens array 10C1 may be produced without partitions 35, such as by casting the transparent substance 46, such as refractive index greater than 1.1.

A saw 38 or a milling drill 86 or a laser beam 33 focused on the lens surface cuts a gap 48A from side 44A not all along.

FIG. 18 describes the second step of producing the lens array of FIG. 13 or FIG. 14.

At the second step, non-transparent liquid glue 50A may be poured or injected into gap 48A.

FIG. 19 describes the third step of producing the lens array of FIG. 13 or FIG. 14.

At the third step, saw 38 or a milling drill 86 or focused laser beam 33 may cut a gap 48B from side 44B not all along. Dried glue 50A within gap 48A ensures non breaking due to gaps 48A and 48B.

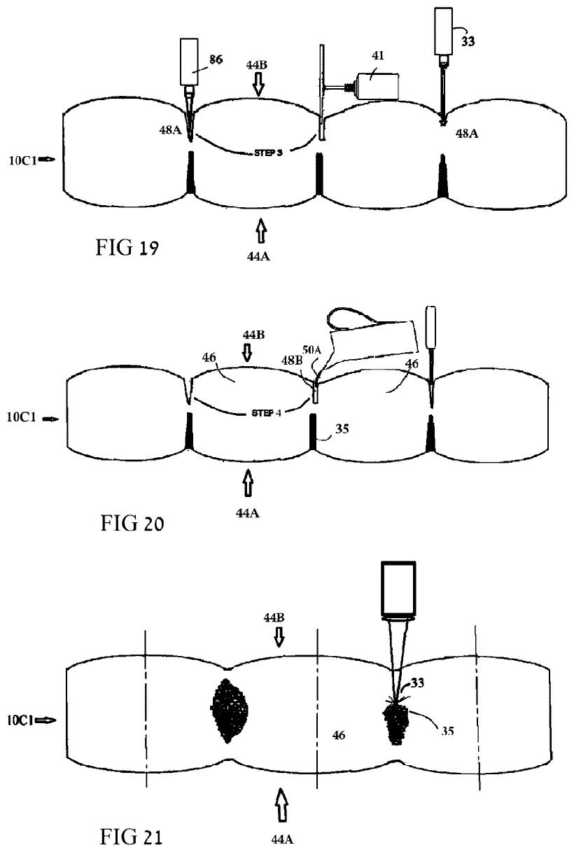

FIG. 20 describes the fourth step of producing the lens array of FIG. 13 or FIG. 14.

At the fourth step, non-transparent liquid glue 50A may be poured or injected into gap 48B.

FIG. 21 describes the production of the lens array of FIG. 13 or FIG. 14 or FIG. 15 according to another embodiment.

At the first step, the lens array may be produced without partitions 35, such as by casting the transparent refractive substance 46.

At the second step, the partition 35 is performed by focusing laser beam 33 into substance 46 for producing micro cracks in it, like in 3D sub surface laser engraving technic.

Producing of the partitions according to FIG. 13-to FIG. 21 may according to another embodiment be performed on a substrate or polymer layer 49A of FIG. 16, and the optical micro-lenses will be applied onto substrate 49A using mechanical grinding or stamping process.

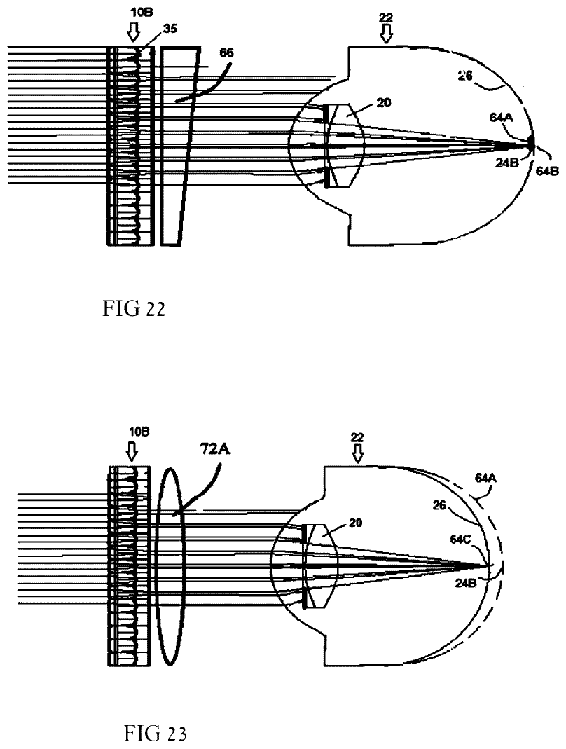

FIG. 22 is similar to FIG. 12, except for an addition of a prism.

A prism 66 may be attached to refractive panel 10B of spectacles 10A for shifting image 24B from point 64A of retina 26 to point 64B, in case point 64B senses better.

Refractive panel 10B may itself include prism 66.

FIG. 23 is similar to FIG. 13, except for an addition of a lens.

A positive or negative lens 72A may be attached to refractive panel 10B of spectacles 10A for adding correction optical power for a user having hyperopic or myopic or astigmatic vision, that shift image 24B to point 64C, where retina 26 actually is located.

Refractive panel 10B may itself include lens 72A.

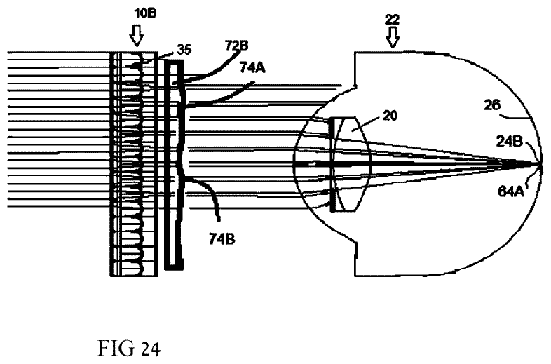

FIG. 24 is similar to FIG. 13, except for an addition of an optical correction plate.

An optical correction plate 72B may be attached to refractive panel 10B of spectacles 10A for correcting production errors of refractive panel 10B induced by tolerances. For example correction plate 72B may be parallel except for zones 74A and 74B, being located where refractive panel 10B has been found to produce non parallel exit rays.

Thus, in one aspect, the invention is directed to a lens array (10C1,10C2), including:
a plurality of lenses (40A1,40A2) each including an optical refractive substance (46), the lenses (40A1,40A2) being disposed one aside the other; and
partitions (35) disposed between the optical refractive substances (46) of the lenses (40A1,40A2), for stopping propagation of rays.

Shaping and the disposition of the partitions (35) is for stopping propagation of rays from the optical refractive substance (46) of one (16B1) of the lenses to the optical refractive substance (46) of another one (16B2) of the lenses.

Characters of the lenses (40A1,40A2) preferably are equal, optical axes thereof (68A,68B) are parallel, and characters of the partitions (35) are equal.

The lens array (10C1) may be produced by:
producing the plurality of lenses (40A1,40A2) disposed one aside the other, then cutting a first group of gaps (48A) between the lenses (40A1,40A2) from a first side (44A) thereof, and
   then inserting non-transparent liquid glue (50A) into the first group of gaps (48A), and
   after the glue dries, cutting a second group of gaps (48B) between the lenses (40A1,40A2) from a second side (44B), and
   then inserting non-transparent liquid glue (50A) into the second group of gaps (48B); or by
producing the plurality of lenses (40A1,40A2) disposed one aside the other, then focusing a scanning laser beam (33) inside the optical refractive substances (46), thereby creating micro cracks; or by
molding a transparent parallel wall panel (49E) within a grid (49D), then applying a polymer layer (49A) on the transparent parallel wall panel (49E), then applying a lens array (49B) on the polymer layer (49A); or by
replicating or photo-lithographing the plurality of lenses (40A1,40A2) disposed one aside the other into a polymer layer that is applied on a panel that includes a grid that is applied in the panel during molding the panel.

In another aspect, the invention is directed to an optical refractive panel (10B) including a first lens array (10C1), and a second lens array (10C2), the lens arrays (10C1,10C2) disposed parallel and including a gap (32C) therebetween, wherein an optical axis of each of the lenses (40A1) of the first lens array (10C1) overlaps an optical axis of one the lenses (40B1) of the second lens array (10C2).

The first lens array (10C1) of the optical refractive panel (10B) may include a plurality of identical positive lenses wherein optical axes thereof are parallel, and the second lens array (10C2) may include a plurality of identical negative positive lenses wherein optical axes thereof are parallel, and the optical axes of the first lens array (10C1) may overlap the optical axes of the second lens array (10C2), and the length (88) of the gap (32C) may provide that focal points of the lenses of the first lens array (10C1) overlap focal points of the lenses of the second lens array (10C2), thereby the optical refractive panel (10B) may constitute an array of Galilean telescopes (16B1,16B2).

The partitions (35) of the first lens array (10C1) and the partitions (35) of the second lens array (10C2) may extend one to the other, thereby the extensions of the partitions (35) connect the first lens array (10C1) to the second lens array (10C2).

In another aspect, the invention is directed to a spectacles lens (10A) including the optical refractive panel (10B) characterized as a Galilean telescope.

The spectacles lens (10A) may further include:
a prism (66) attached to the optical refractive panel (10B) for tilting rays for shifting (64B) an image (24B) focused on a retina (26);
a lens (72A) attached to the optical refractive panel (10B) for providing optical power;
a correction plate (72B) attached to the optical refractive panel (10B) for correcting production errors of the refractive panel (10B) induced by tolerances.

In the figures and description herein, the following reference numerals (Reference Signs List) have been mentioned:
numeral 10A denotes spectacles according to one embodiment of the invention;
10B: refractive panel including lens arrays 10C1,10C2;
numerals 10C1,10C2: lens arrays;
12: prior art spectacles;
14: spectacle lens;
16A: prior art telescope attached to spectacle lens 14;
16B1,16B2,16B3: telescope of refractive panel array 10B;
18: viewed object;
20: lens of human eye 22;
22: human eye;
24A,24B: images on retina 26;
26: retina;
28: defective area of retina 26;
30: portion of the image;
32A: positive lens;
32B: negative lens;
32C: air gap;
33: laser beam;
34: ray;
35: optical partition;
36A: entrance angle of ray 34;
36B: exit angle of ray 34;
36C: exit angle of ray 42;
37: ray;
38: saw;
40A1,40A2,40A3: lenses of lens arrays 58A,10C1;
40B1,40B2,40B3: lenses of lens arrays 58B,10C2;
41: motor;
42: entering rays;
44A,44B: sides of lens array 10C1;
46: transparent refractive substance such as glass or plastic;
48A,48B: cuts in transparent refractive substance 46, forming gaps;
49A: polymer layer or substrate;
49B: lens array applied on polymer layer 49A;
49C: lens assembly;
49D: grid;
49E: glass or plastic parallel-wall panel;
50A: non-transparent liquidized glue;
50B: transparent liquidized glue;
58A,58B: lens arrays;
60: mold;
64A,64B: points of retina 26;
66: prism;
68A: optical axis of lens 40A1 of lens array 10C1;
68B: optical axis of lens 40A2 of lens array 10C1;
72A: lens;
72B: optical correction plate;
74A,74B: non parallel zones of optical correction plate 72B.
83: extension of negative lens;
84A,84B: angles;
86: milling drill;
88: length of gap 32C;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A method for producing a lens array comprising a plurality of lenses each comprising an optical refractive transparent substance, said lenses being disposed one next to the other, and partitions disposed between said optical refractive substances of said lenses,
the method comprising one of the three procedures of:
producing said plurality of lenses disposed one next to the other, then cutting a first group of gaps between said lenses from a first side thereof, and
then inserting non-transparent liquid glue into said first group of gaps, and
after the glue dries, cutting a second group of gaps between said lenses from a second side, and then inserting non-transparent liquid glue into said second group of gaps,
thereby said non-transparent liquid glue comprises said partitions;
producing said plurality of lenses disposed one next to the other, then focusing a scanning laser beam inside said optical refractive substances, thereby creating micro cracks comprising said partitions;
inserting transparent liquid into a parallel wall mold containing a grid comprising said partitions, then applying a polymer layer on said transparent parallel wall panel, then replicating a plurality of lenses one next to the other on said polymer layer.

2. The method according to claim 1, wherein shaping and said disposition of said partitions is for reducing propagation of rays from said optical refractive substance of one of said lenses to said optical refractive substance of another one of said lenses.

3. The method according to claim 1, wherein said lens array comprising at least one of:
focal lengths of said lenses are equal;
optical axes thereof are parallel; and
said partitions are equal.

4. The method according to claim 1, for producing an optical refractive panel comprising a first lens array according to claim 1, and a second lens array according to claim 1, said lens arrays disposed parallel and comprising a gap therebetween, wherein an optical axis of each of said lenses of said first lens array overlaps an optical axis of one said lenses of said second lens array.

5. The method according to claim 4,
wherein said first lens array comprise a plurality of identical positive lenses wherein optical axes thereof are parallel, and said second lens array comprise a plurality of identical negative positive lenses wherein optical axes thereof are parallel,
wherein said optical axes of said first lens array overlap said optical axes of said second lens array, and
wherein a length of said gap provides that focal points of said lenses of said first lens array overlap focal points of said lenses of said second lens array,
thereby said optical refractive panel comprises an array of Galilean telescopes.

6. The method according to claim 5, wherein said partitions of said first lens array and said partitions of said second lens array extend one to the other, thereby said extensions of said partitions connect said first lens array to said second lens array.

7. The method according to claim 4, for producing a spectacles lens comprising said optical refractive panel.

8. The method according to claim 7 for producing said spectacles lens, wherein said spectacles lens further comprising at least one of:
a prism attached to said optical refractive panel for tilting rays for shifting an image focused on a retina;
a lens attached to said optical refractive panel for providing optical power;
a correction plate attached to said optical refractive panel for correcting production errors of said refractive panel induced by tolerances.

9. The method according to claim 7 for producing said spectacles lens, wherein said optical refractive panel further comprises at least one of:
a prism for tilting rays for shifting an image focused on a retina; and
a lens for providing optical power.
